(19) United States
(12) Patent Application Publication
(10) Pub. No.: US 2004/0188105 A1
(43) Pub. Date: Sep. 30, 2004

(54) Method of earthworking

(76) Inventor: Patrick Newnam, Bowling Green, OH (US)

Correspondence Address: PATRICK NEWNAM, 1015 CLOUGH ST., BOWLING GREEN, OH, 43402, US

(21) Appl. No.: 10/798,114

(22) Filed: Mar. 11, 2004

Related U.S. Application Data
(62) Division of application No. 10/102,069, filed on Mar. 20, 2002, now abandoned.

(51) Int. Cl. A01B 15/00

(52) U.S. Cl. 172/1

(57) ABSTRACT

A method of working or shaping a surface in situ. The earthworking tool of the invention is engaged with the surface in situ and is propelled about the surface by the motive source. The motive source is capable of moving the apparatus in any direction on the surface while it is engaged in working the surface. The tool carrier assembly of the apparatus is pivotably attached to the motive source and may be urged to rotate about an axis that is somewhat perpendicular to the surface being worked. The earthworking tool may then be moved in any other direction desired, by the action of the motive source, without disengaging the earthworking tool from the surface being worked.

### BACKGROUND—CROSS-REFERENCES TO RELATED APPLICATIONS

This application is a division of Ser. No. 10/102069, Filed Mar. 20, 2002

### BACKGROUND—FIELD OF INVENTION

This invention relates to earthworking scrapers, specifically those that pivot around a vertical axis.

### BACKGROUND—DESCRIPTION OF PRIOR ART

Earthworking scrapers are well known in the art. They are designed to be pushed, pulled, or both pushed and pulled. The implements are either self propelled or propelled by a separate, detachable motive source. There are many various arrangements for the adjustment of the blade position. The prior art is replete with ways to control the depth of the grading tool, including depth guides such as skids, wheels, rollers and the like.

Many grading implements are designed to be connected to utility vehicles by means of a three point hitch. This allows for the disengagement of the tool with the surface of earth, or other material being graded, by raising the implement. This lifting of the grader is necessary to position the implement to grade in a different direction. The disengagement of the grader is time consuming and inefficient.

The three point hitch does not allow the application of any additional downward pressure on the grading tool, in some cases allowing the tool to ride up over a high spot on the surface being graded, and often requiring repeated attempts to shave the material being graded down to the required elevation. U.S. Pat. No. 2,749,631 to Thompson (1956) discloses a three point hitch scraper blade that rotates around a vertical axis. This type of implement, having limited means of depth control, tends to cut too deeply in areas of loosened soil. Constant depth adjustment of such implements, is required to achieve the desired result. The three point hitch is commonly used as a rear hitch on a tractor. The monitoring of the grader attached with a three point hitch mechanism causes the operator of the tractor to twist around to look to the implement and causes operator discomfort and fatigue.

A depth control device, which requires less operator attention to achieve the desired cut and fill results, is commonly used in the art. U.S. Pat. No. 3,234,669 to Kachnik (1966) shows a wheel as an effective depth control device. Wheels or rollers are frequently employed for this purpose. The caster wheel is well known and used in the art as a means of depth control for a scraper blade. This rotateable wheel attachment may also serve as an effective ground support member. The castering motion of the wheel does not change the orientation of the scraper blade resulting in a limited effectiveness of the scraper in sharp turning maneuvers.

Earthworking scrapers, designed to be towed behind a vehicle, are present in the prior art. U.S. Pat. No. 6,112,828 to Leal (2000) shows an implement that has pivotably attached wheels, whose adjustment provides a controllable means of raising or lowering the blade. The simple pivoting on a pin hitch arrangement, commonly used to connect the implement to the tow vehicle, does not allow the implement to be lifted off the ground. Repositioning the implement requires more space to maneuver, and this type of grading implement is more difficult to use in confined spaces, or areas where there are obstacles to maneuver around.

Bi-directional surface leveling implements are more efficient due to their ability to grade in one direction, stop, and reverse direction without repositioning the implement or disengaging the tool from the surface being graded. U.S. Pat. No. 6,168,348 B1 shows a type of implement, when attached to a skidsteer utility vehicle, that has a wider range of possible movement than most grading implements. However, it is still frequently necessary to reposition the implement when grading in confined spaces or when working around obstacles. In the process of turning the skidsteer vehicle the surface being worked is often disturbed and requires additional leveling.

A well developed area of the art employs a blade that pivots around a vertical axis. This gives the implement added capability to move the materials being worked lateral to the direction of the draft more effectively. These implements, however, do not provide an effective means for moving the implement as a whole in a lateral direction.

Multiple blades for moving earth laterally to the direction of the draft of the implement exist in the prior art. U.S. Pat. No. 6,283,225 B1to Hermonson (2001) shows an implement attached to a skidsteer utility vehicle capable of such action. To reposition such an implement of this type the turning action of the skidsteer disturbs the surface being worked and necessitates another pass with the implement to grade the surface again. An implement of this type does not have the ability to adjust the height of the blades effectively. The earthworking scrapers available today suffer from a number of disadvantages:

(a) Grading implements currently available require a disengagement from the surface being worked to reposition the implement for a change of direction.

(b) The skidsteer utility vehicles commonly used for a motive source cause a disturbance of the surface being worked as a result of their mode of turning in a short radius.

(c) Most graders have no ability to move soil in one direction, stop and without disengaging from the surface being worked, move the soil in any other desired direction.

(d) Poor visibility of the scraper blade is a common problem.

(e) Many of the graders in use today have a limited range of depth control adjustment

(f) An inability to apply downward pressure while turning sharply is a disadvantage of the currently available implements.

(g) A limited adaptability to different soil conditions necessitates waiting for the ideal conditions before attempting to perform the earthworking task.

(h) Most of the currently available graders have objects extending beyond the lateral edges of the scraper that can damage trees, houses, and other valuable objects at the work site as the grader is being used.

(i ) A grader that has the ability to rotate on a vertical axis and still provide a source of hydraulic fluid to the ground contact component is unavailable in the market place today.

### SUMMARY

In accordance with the present invention an earthworking scraper comprises a controllable scraper blade supported by a depth guide, or roller, functioning as a unit that is pivotable around a vertical axis, while powered by a highly maneuverable motive source.

### OBJECTS AND ADVANTAGES

Accordingly, in addition to the objects and advantages set forth above in my patent application, further objects and advantages of the present invention are:

(a) to provide an earthworking scraper that can create a smooth level surface on any material being worked in situ and easily and quickly perform a turning maneuver without disengaging from the surface being worked;

(b) to provide a grader that is removably attached to a skidsteer type of utility vehicle and allows the motive source to turn in a tight turning radius with the front wheels of the skidsteer elevated off the ground without disturbing the surface being worked;

(c) to provide a grader that can grade in any direction, stop and turn the skidsteer in a cyclonic or anti-cyclonic motion and cause the grader to move soil in a lateral direction and then quickly move in any other desired direction pushing the soil wherever it needs to go;

(d) to provide a grader that is out front of the operator of the skidsteer and a scraper blade whose edges are easily seen while engaged in grading a surface in situ, so that the implement can grade very close to sidewalks, houses, and other such fixed obstacles at the work site;

(e) to provide for a grader whose cutting edge height can be easily controlled to achieve complex grading maneuvers on a variety of terrain;

(f) to provide for a grader capable of putting downward pressure on the ground support wheels or rollers to enable the cutting edge to carve the high areas without riding up over the top of the high spots and still be able to turn while performing the task;

(g) to provide for a grader that can easily and quickly change the ground support rollers to adapt to different soil conditions at the work site resulting in a wider window of opportunity for work;

(h) to provide for a grader with sides that are smooth to allow the operator to maneuver close to delicate objects without damaging them.

(i) to provide for the transfer of hydraulic fluid to a grader that can be rotated around a vertical axis in either direction and for as many revolutions as necessary with no twisting of the hydraulic lines.

Further objects and advantages are to provide a grader that is easily attached to a skidsteer utility vehicle that takes advantage of the highly maneuverable nature of the skidsteer and performs simple or complex grading tasks quickly and easily while affording the operator a highly controllable earthworking tool. Still further objects and advantages will become apparent from a consideration of the following description and drawings.

### DRAWING FIGURES

In the drawings, closely related figures have the same number but different alphabetic suffixes.

FIG. 1 shows an elevation view of the motive source attached to the grader with a hydraulically controlled grader box.

FIG. 2 shows a perspective view of the grader with a hydraulically controlled grader box.

FIG. 3 shows an exploded perspective view of pivoting components.

FIG. 4 is a perspective view of the assembled components of FIG. 3

FIG. 5 is view in detail of the portion indicated by the section lines 5-5 in FIG. 4.

FIGS. 6A and 6B is a detail of a component of FIGS. 3 and 5.

FIG. 7 is a perspective view of an alternative embodiment of FIG. 4.

FIG. 8 is a view in detail of the portion indicated by section line 8-8 in FIG. 7.

FIG. 9 is an exploded view in detail of a component of FIGS. 1 and 2.

FIG. 10 is a perspective view of an alternative embodiment of FIGS. 1 and 2.

FIG. 11 is a perspective view of an alternative embodiment of FIGS. 1 and 2.

FIG. 12 is a perspective view of an alternative embodiment of FIGS. 1 and 2.

FIG. 13 is an exploded view in detail of a component of FIGS. 1 and 2.

FIG. 14 is a perspective view of an alternative embodiment of FIGS. 1 and 2.

### REFERENCE NUMERALS IN DRAWINGS

20 motive source

22 lift arm assembly

23 lift arm ram

24 chassis

25 tilt ram

26 tilt mechanism

28 hydraulic fluid pressure connection

29 hydraulic fluid return connection

30 front wheels of motive source

32 connection foot

34 locking mechanism

35 attachment shoe

36 support structure

37 main body

38 proximal end

39 hydraulic motor

40 housing

41 solenoid activated hydraulic valve assembly

42 control wire harness

43 P motor hose

43 R motor hose

44 P pressure hydraulic hose

44 R return hydraulic hose

46 bolt

48 A bolt

48 B nut

49 distal end

50 hydraulic swivel sleeve

51 rotary hydraulic coupling

52 passage O-ring

52 A annular channel O-ring

53 oil seal

54 P hydraulic fluid passage

54 R hydraulic fluid passage

55 P fluid port

55 R fluid port

56 cap

57 P annular channel

57 R annular channel

58 shim

59 M mating surface

59 F mating surface

60 upper bearing assembly

62 lower bearing assembly

64 grease seal

65 P tool carrier hose

65 R tool carrier hose

66 P service fluid port

66 R service fluid port

67 clamp seat

68 retaining clamp

70 key

72 primary gear

74 drive gear

76 shaft

77 tee bar

78 power shaft

79 key-way

80 dry shaft

82 rocking pin

84 retainer bolt

85 F mid point sleeve

85 R mid point sleeve

86 adjustable frame

87 F front strut

87 R rear strut

88 wing tip pin

90 wing tip sleeve

91 wing tip carrier bushing

92 tool carrier assembly

92A tool carrier assembly

94 cutting edge

96 scraper blade

96A scraper blade

98 end plate

98A end plate

99 eyebrow stop

100 roller

101 ground contact surface

102 roller bearing carrier assembly

103 hub

104 axle

104A axle

105 sliding collar

106 mid-plate

107 set screw

107A set screw

108 axle roller bearing assembly

109 locking tang

110 hub nut

111 dust cover

112 clevis pin

113 tab

114 ram base

115 ram

116 ramrod

117 ram pivot pin

118 retaining clip

119 disc

120 cross member

121 long cross member

122 back plate

122A back plate

124 mounting plate

126 dry shaft cap

128 rack gear

130 slide channel

132 equalizer frame

134 equalizer pin

136 single roller tool carrier assembly

138 half size mounting plate

140 pulley

142 pulley bearing

144 washer

145 axle bolt

146 inner mount

148 locking arm

150 hook

152 lever

154 lever pin

156 snap ring

158 block

160 block pin

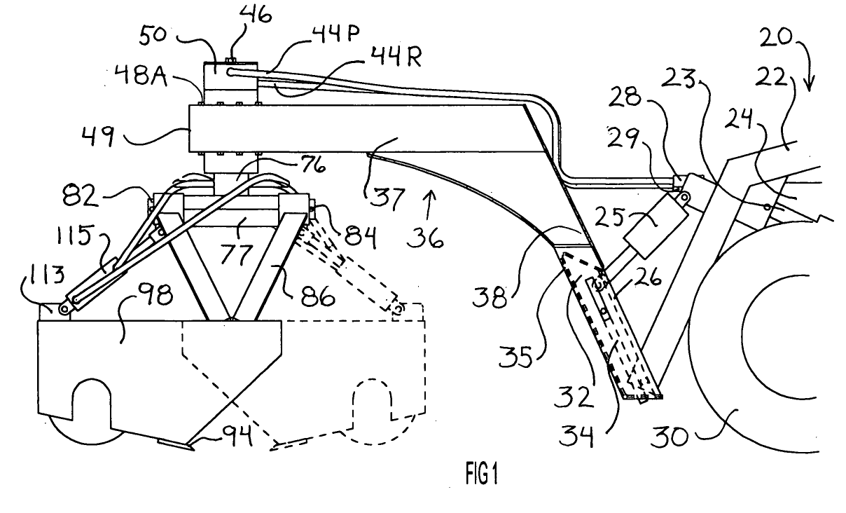

FIGS. 1,2,3,4,5,6,9—Description of the Preferred Embodiment

FIG. 1 shows a side elevation view of a grader. A motive source 20 of the type known as a skidsteer loader comprising; an engine mounted within a chassis 24, a source of electrical generation, an operators compartment, a pair of front wheels 30, a pair of rear wheels, a variable speed direction control for the left side front and rear wheels, a second variable speed direction control for the right side front and rear wheels, a hydraulic power source, an auxiliary hydraulic control, and a hydraulic lifting mechanism with multiple pivot points, is shown with the grader attached to it. A support frame or support structure 36 extends outwardly and journals a vertical shaft 76. The shaft is integrally connected to a tee-bar 77. The tee-bar is attached to an adjustable frame 86, which is in turn connected to a tool carrier assembly 92.

A lift arm assembly 22 on the motive source comprises; a lift arm on both sides of the skidsteer which extends outward from the forward end of the skidsteer, and a cross brace that joins the two lift arms together near the forward end of the lift arms. A hydraulic fluid pressure connection 28 and a hydraulic fluid return connection 29 are located on one of the lift arms. The lift arms are pivotally connected to the aft section of the skidsteer chassis. A lift arm ram 23 is pivotally connected to each lift arm.

A tilt mechanism 26 extends outwardly from the forward end of the lift arm assembly. The tilt mechanism is pivotally connected to the lift arm assembly. A tilt ram 25 is also adjustably linked to the lift arm assembly by one or more hydraulically controlled mechanisms A connection foot 32 is integrally constructed as part of the tilt mechanism. Integrally formed as part of the connection foot is one or more elements of a locking mechanism 34. The locking mechanism locks the grader to the motive source.

In FIG. 1 an attachment shoe 35 shown is integrally attached to a proximal end 38 of a main body 37 of the support structure. The locking mechanism locks the connection foot into a nested position with the attachment shoe as a means of attaching the support structure to the motive source in preparation for use of the implement.

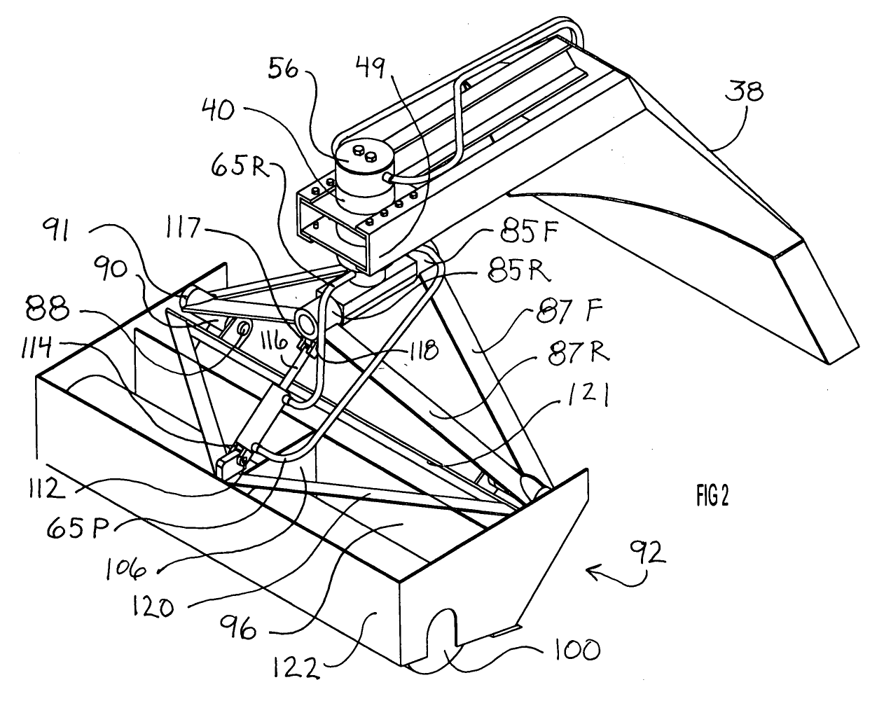

In FIGS. 1 and 2 main body 37 is an overarching beam that extends outwardly from the motive source. The beam comprises two lengths of rigid material lying parallel to one another in a somewhat horizontal orientation and rigid plates that integrally connect the beam to the connection foot. The lengths of rigid material have three flat sides joined together at the edges at perpendicular angles to one another. The middle side has a greater width than the other two sides an is in a somewhat vertical orientation. The shorter sides have a somewhat horizontal orientation and extend toward the horizontal sides on the matching beam. The two lengths of rigid material are joined together by a plate of rigid material that is integrally attached to a distal end 49 of the main body of the support structure. A second rigid plate is integrally attached to the bottom edge of the beam and extends downward to the outer corner of the connection foot. A third rigid plate that mirrors the second rigid plate is integrally attached to the opposite side of the beam as the second rigid plate and is integrally attached to the opposite comer of the connection foot. The two matching lengths of rigid material which form the beam have holes in the four short sides that extend toward the middle of the beam. The holes are located at precise intervals that match holes on a flange that is integrally connected to a housing 40. The housing is rigidly attached to distal end 49 of the main body of the support structure.

The flanges are integrally attached to the outer circumference of the housing on two parallel planes that are perpendicular to the sides of the cylinder that forms the housing. In FIG. 1 a bolt 48A and a nut 48B are securing the housing to the support structure.

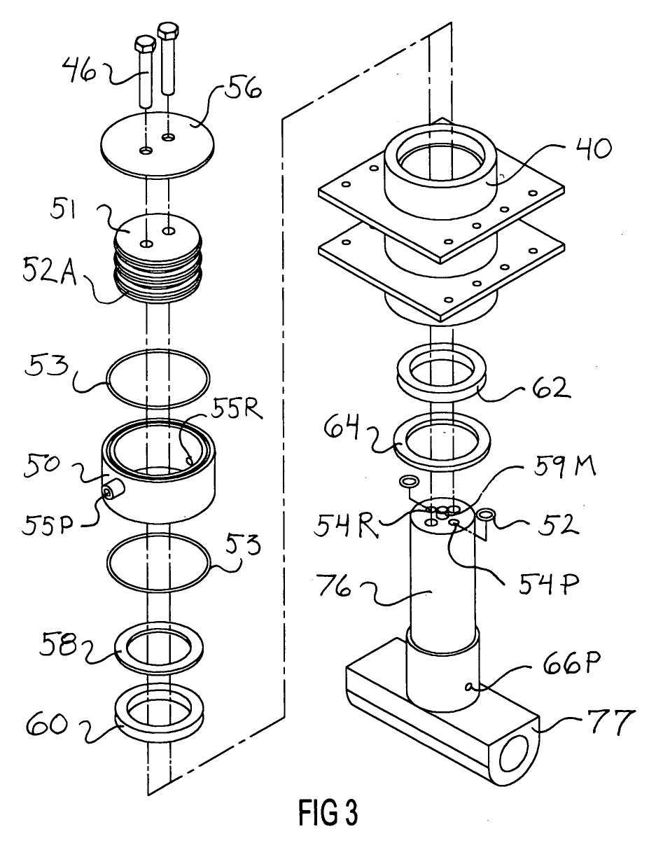

In FIG. 3 housing 40 is a hollow cylinder of rigid material that has a thickness that allows for the shaping of the interior wall of the housing. The middle section of the housing is thicker than the top section or the bottom section. The middle section has a smaller inside diameter than the upper or lower sections of the housing. The larger diameter of the upper and lower sections of the housing matches the outer contact surfaces on, and retains, an upper bearing assembly 60 and a lower bearing assembly 62. The two sets of tapered roller bearings operating in opposition to one another journal the somewhat vertical shaft 76 within the housing. The somewhat vertical shaft is aligned on a somewhat vertical first axis. The housing is a means to retain the somehat vertical first axis in a fixed position relative to the support structure.

In FIG. 3 the shaft has outer surfaces that are shaped to match the inner diameter of the bearing surfaces. The upper portion of the shaft, which is journalled by the tapered roller bearings, has a smaller diameter than the lower portion of the shaft.

A grease seal 64 is retained in the housing at a point at some distance below lower bearing assembly 62. Upper bearing assembly 60 is in contact with a shim or spacer 58. These shims contact the outer circumference of the lower end of a rotary hydraulic coupling 51. A bolt 46 attaches coupling 51 to shaft 76 through a vertical hole drilled through the interior of the rotary coupling and into the shaft. Bolt 46 attaches the rotary coupling to the shaft through a second hole drilled vertically through the rotary coupling and into the shaft. The bolt holes are centered on a vertical plane that bisects shaft 76

The holes in the shaft are threaded to retain the bolts. The bottom surface of coupling 51 has a mating surface 59M, which interfaces with a mating surface 59F on the top of shaft 76.

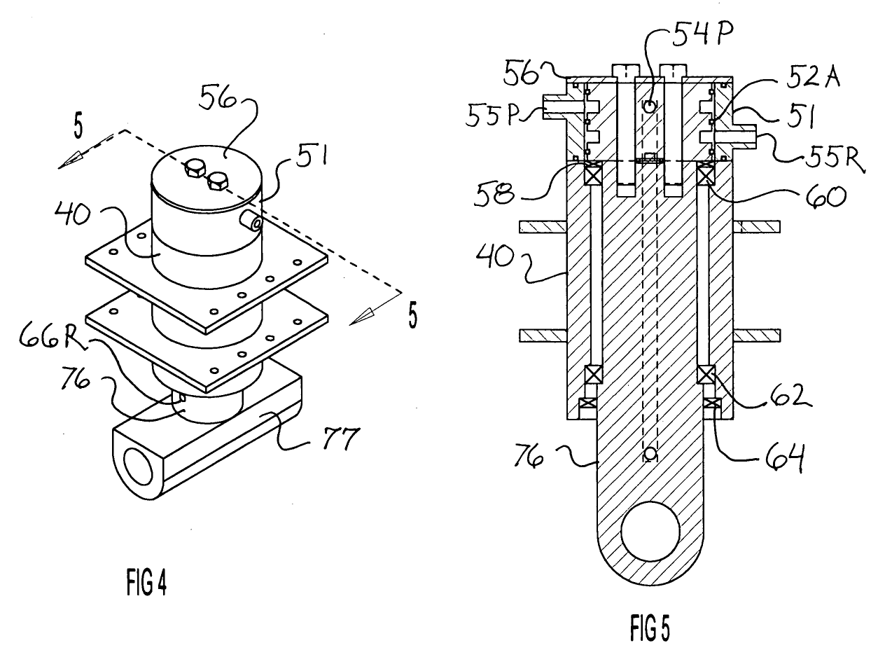

In FIGS. 5A and 5B coupling 51 has an annular channel 57P cut into the outer cylindrical surface along a horizontal plane. An annular channel 57R is cut into the outer surface of the coupling along a second plane that is parallel to but below the first plane of channel 57P. The two channels are separated by a portion of the surface of the coupling. A hydraulic fluid passage 54P extends inward horizontally from the inner vertical surface of annular channel 57P and then downward through the interior of hydraulic coupling 51. A hydraulic fluid passage 54R extends inward horizontally from the inner vertical surface of annular channel 57R and then downward through the interior of coupling 51. In FIGS. 3 and 4 these fluid passages continue downward through the interior of shaft 76 and are centered on a vertical plane that bisects shaft 76. This vertical plane is perpendicular to the vertical plane that the bolt holes of shaft 76 are centered on. In FIG. 5 an O-ring 52 seals the junction of the vertical hydraulic passages in coupling 51 and shaft 76. The O-rings are seated in grooves machined into coupling 51. The annular channels are separated from one another by an O-ring 52A. The annular channels are defined at their outer edges by a hydraulic swivel sleeve 50.

In FIG. 3 swivel sleeve 50 is a cylinder that surrounds the rotary hydraulic coupling 51. The sleeve 50 has two separate holes with female threads which are located accordingly to lead to each of the two channels 57. An Oil seal 53 is retained in the spaces between sleeve 50 and housing 40 at the lower end of swivel sleeve 50 and at the upper end of sleeve 50 by a cap 56. The cap is secured to coupling 51 by bolts 46. An upper fluid port 55P is joined to the hydraulic fluid pressure connection at the motive source by a hydraulic hose 44P. A lower fluid port 55R is joined to the hydraulic fluid return connection 29 at the motive source by a hydraulic hose 44R.

In FIG. 3 a service fluid port 66P is connected to channel 54P on shaft 76. A service port 66R is connected to channel 54R on the opposite side of shaft 76. The service fluid ports exit the shaft an equal distance below the lower opening of housing 40.

In FIGS. 2 and 3 tee bar 77 is integrally attached at its midpoint to the bottom of the shaft 76. The tee bar is perpendicular to the shaft and has a hollow core to journal a rocking pin 82. The pin 82 is journalled at both ends of the tee bar by adjustable frame 86. The rocking pin is retained in position by a retainer bolt 84, one at each end.

In FIG. 2 the adjustable frame 86 is a structure resembling a pair of wings in flight, on the downward beat. Frame 86 comprises a forward midpoint sleeve 85F having an inside diameter identical to the inside diameter of tee bar 77, and a rearward midpoint sleeve 85R having an identical inside diameter also. The sleeves 85F and 85R are separated by the length of the tee bar and positioned to be in line with one another. A strut 87F is integrally connected to the forward midpoint sleeve 85F and extends outward and downward and is integrally joined to a wing tip sleeve 90 at the end of the strut 87F. A second strut 87R is also integrally connected to the wing tip sleeve 90 and extends back to midpoint sleeve 85 R. The second pair of struts are attached to their respective midpoint sleeves 85F and 85R and are joined at their outward tips to the second wing tip sleeve. The two wing tip sleeves are separated by a predetermined distance and are in alignment on a somewhat horizontal, third horizontal axis. The wing-like frame is formed by four struts which form the sides of two isosceles triangles which share a common base. This common base is formed by the tee bar and midpoint sleeves 85F and 85R as they journal rocking pin 82. The rocking pin is aligned on a somewhat horizontal first horizontal axis which is perpendicular to and non co-planer in relation with the somewhat horizontal third horizontal axis on which the wing tip sleeves pivot.

The two wing tip sleeves each journal a wing tip pin 88 which is horizontally retained and is also journalled by a wing tip carrier bushing 91. The bushing is integrally attached to the tool carrier assembly, and to a long cross member 121. The adjustable frame is connected to tool carrier assembly 92 at a third connection point disposed rearwardly at a predetermined distance below rearward midpoint sleeve 85R, and equidistant from either wing tip. This third connection point is pivotally linked by a ram pivot pin 117 to the outer end of a ram rod 116.

In FIG. 2 a ram 115 is a hydraulic cylinder assembly which is well known in the art. The ram has two ports for hydraulic fluid. A tool carrier hose 65P attaches to one of the fluid ports on the ram. A tool carrier hose 65R attaches to the second fluid port on the ram. The tool carrier hoses attach to the service fluid ports on shaft 76. A ram base 114 is at the opposite end of the ram from the ram rod. A clevis pin 112 pivotally connects the ram base to the tool carrier assembly.

In FIG. 2 the tool carrier assembly is the ground contact component of the grader comprising; a cutting edge 94, a scraper blade 96, a mid-plate 106, a roller 100 on one side of the mid-plate, roller 100 on the other side of the mid-plate, an end plate 98 at each end of the scraper blade, a cross member 120 on one side of the mid-plate, another cross-member on the other side of the mid-plate, long cross-member 121 between the two end plates, an axle 104 on the axis of each of the rollers and a roller bearing carrier assembly 102 attached to the ends of the axles.

In FIG. 2 cutting edge 94 is an elongated hardened steel bar, with its leading edge tapered to a somewhat sharpened edge that is disposed at a downward angle. The cutting edge is level with the bottom of the rollers. The cutting edge is oriented perpendicular to the draft of the tool carrier assembly. The cutting edge is integrally attached to the lower edge of the scraper blade. The cutting edge lies on a plane that bisects the somewhat vertical plane of the scraper blade. The cutting edge extends forward of the axis that is formed by the intersection of the plane of the cutting edge and the plane of the scraper blade. The cutting edge axis is parallel to the axis of the rollers that function as the ground contact surface.

In FIG. 2 scraper blade 96 is elongated and is approximately the same length as the cutting edge. The blade is attached to the upper surface of the cutting edge, rearward of the tapered leading edge of the cutting edge. The scraper blade extends vertically and is integrally attached at its midpoint to the rearwardly depending mid-plate.

The mid-plate in FIG. 2 lies within a vertical plane that is perpendicular to the scraper blade. It extends rearward and bisects the part of the tool carrier assembly that is aft of the scraper blade. A tab 113 is the pivot able connection point to ram base 114. It is an upwardly extending appendage integrally attached to the upper edge of mid-plate 106, near the aft edge of the mid-plate. The tab lies in the same vertical plane as the mid-plate. Clevis pin 112 passes through a hole in the tab to pivotally connect the ram base to the tab. A retaining clip 118 on each end of the clevis pin retains the pin in place.

In FIG. 2, two end plates are parallel with the mid-plate and are integrally attached to opposite ends of the cutting edge and the scraper blade. The point at which the end plates attach to the cutting edge is level with the bottom of the rollers. The bottom margin of the end plates rises as it continues rearward to join the back plate. There is an arch shaped cutout to allow access to the end of roller bearing carrier assembly 102. Integrally attached to a point near the forward edge of the end plates at the inward surface of the end plates are the sleeves which journal the outward ends of wing tip pins. The inboard end of the wing tip pins are journalled by sleeves on the long cross member. These pins pivotally connect the tool carrier assembly to the adjustable frame. These connection points are forward of the scraper blade.

A back plate 122 lies within a vertical plane that is parallel with the vertical plane of the scraper blade and is integrally attached to the rearmost edges of the mid-plate and the two end plates.

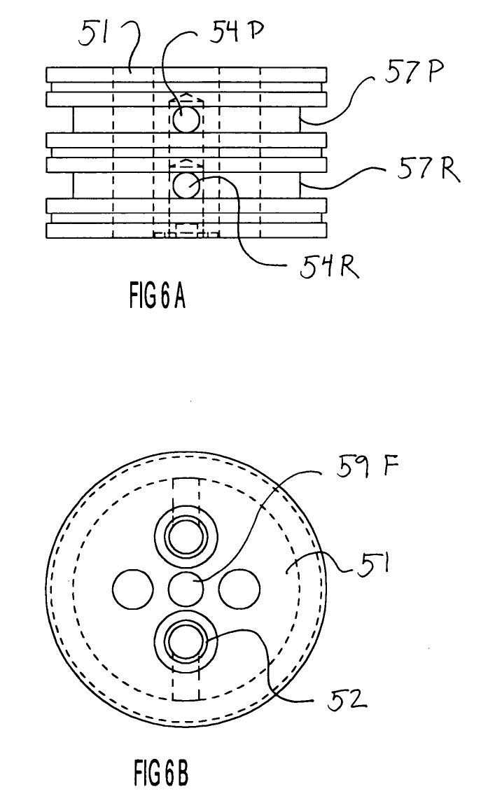

In FIG. 6 an eyebrow stop 99 is integrally attached to both sides of the mid-plate aft of the scraper blade. The eyebrow is essentially a half circle shape affixed with the open end in the downward position. The eyebrow stop is a segment of a circular steel plate having a thickness providing sufficient mass to withstand the forces required to operate the invention. The eyebrow stop has a convex surface defined by an arc whose radius is centered on the somewhat horizontal, second horizontal axis about which the rollers rotate. The eyebrow stop has a concave surface defined by a shorter radius that has it's center at the same point on the horizontal axis. Eyebrow stops 99 are attached to the inboard surfaces of the endplates equidistant from the same horizontal axis. A roller bearing carrier assembly 102 nests with the concave surface of the eyebrow stop.

In FIG. 6 roller bearing carrier assembly 102 comprises; an pair of axle roller bearing assemblies 108 housed within a machined steel hub 103, a sliding collar 105, a set screw 107, a locking tang 109, a hub nut 110, a dust cover 111, and a set screw 107A. Sliding collar 105 is a cylindrical shaped component of the roller bearing carrier assembly and has an inside diameter that is approximately the same as the arc of the convex surface of the eyebrow stop. A hole is threaded from the outside of the surface of the cylinder of the sliding collar through the thickness of the collar. The inner diameter of the collar also matches the outside diameter of a surface of hub 103. The inside diameter of the surface of the bearing race of the axle roller bearing assemblies match a surface on the axle. The above described integrally attached end plates, mid-plate, and eyebrow stops, together with the carrier bearing assemblies, provide a means for retaining the axis about which the rollers rotate and the scraper blade in a somewhat fixed position in relation to one another.

In FIGS. 2 and 6 roller 100 comprises; axle 104 that is integrally attached to the center of a disk 119. The disk lies within the interior of and perpendicular to the cylinder of a ground contact surface 101. A multiplicity of disks are integrally attached to the inside of the ground contact surface that forms the outer surface of the cylindrical rollers. Axle 104 extends some predetermined distance beyond the ends of the cylinder that forms the ground contact surface. The axle is threaded on both ends and has a key way machined from the end toward the center of the axle a predetermined distance.

FIGS. 1,2,3,4,5,6,9—Operation of the Preferred Embodiment

The grader is shown if FIG. 1 attached to a skidsteer loader. The skidsteer is the preferred motive source because of its high degree of mobility. The operator has a high degree of control over the speed and direction of the skidsteer due to the bilateral nature of the power controls. The bilateral power controls provide a means of moving in multiple directions. A variable speed direction control activates the left side set of wheels, causing them to move in unison in either a clockwise or counter clockwise rotation. A variable speed direction control activates the right side set of wheels causing them to move in unison in the same manner. The hydraulic power source provides fluid power as a means of propulsion for the four wheels while the skidsteer is at work on a surface. Fluid power is also provided as a means to operate the lift arms, conveying upward or downward force through the lift arm assembly of the skidsteer. Hydraulic power is also provided as a means to power auxiliary hydraulic implements that may be attached to the skidsteer.

Lift arm assembly 22 can be elevated or lowered to any desired height within the range of motion of rams 23 that are pivotally connected to the lift arms. In the lowest position of the lift arms, side shifting of the lift arms is restricted by contact with skidsteer chassis 24. The tilt mechanism is pivotally connected to the forward end of lift arm assembly 22. The tilt mechanism rotates around a horizontal axis that is oriented perpendicular to the vertical plane that bisects the skidsteer laterally. Tilt ram 25 is pivotally attached and is a means to allow the support structure to pivot controllably about the axis that is perpendicular to a vertical plane that bisects the motive source laterally. Hydraulic fluid pressure connection 28, and hydraulic fluid return connection 29 are affixed to the lift arm assembly for use in powering auxiliary attachments that may be connected to the skidsteer. The lift arms are capable of such downward force as to lift the front of the chassis in an upward direction. This upward tilting attitude of the chassis of the skidsteer causes the two front wheels to be lifted off the ground and the two rear wheels to remain on the ground.

Connection foot 32 is shaped to allow the attachment of a number of implements to the skidsteer. The locking mechanism is manually activated or deactivated to hold in place or to release attachment shoe 35. The attachment shoe locks onto the connection foot in a tightly locked condition by the locking mechanism to resist separation from the skidsteer, providing a means of attaching the lift arm assembly of the motive source to the support structure.

The support structure is designed so as to resist bending and twisting and to function as a rigid extension of the lift arm assembly. It is designed to be in the level position with the lift arms raised a few inches from the full downward position with the skidsteer and implement resting on a level surface. The main body functions to hold housing 40 near distal end 49 of the support structure. This allows tool carrier assembly 92 to rotate in unison with the shaft, as it is journalled inside the housing, around a somewhat vertical axis. The shaft journalled in the housing is a first means of pivotable connection of the support structure to the adjustable frame. The combination of pivotable connections between the skidsteer lift arm assembly, the tilt mechanism, support structure and housing, the shaft and tee bar, the adjustable frame, and the tool carrier assembly, also collectively constitute a means of pivotable connection of the motive source to the tool carrier assembly. This collective means of pivotable connection allows the tool carrier assembly to rotate controllably about a somewhat vertical axis. As the tool carrier rotates it is held at a distance so that its rotation is not impeded by the proximal end of support structure 38.

This somewhat vertical axis can be tilted on a vertical plane that bisects the skidsteer along a centerline from the front to the back of the skidsteer. The fore and aft tilting can be caused by activation of the tilting mechanism of the lift arm assembly, also providing a first means of depth control of the cutting edge and scraper blade, or by raising or lowering the lift arms.

This same vertical axis will vary along a vertical plane that is perpendicular to the centerline plane as the skidsteer rocks from side to side when in motion, or when the skidsteer is tilted to one side or the other.

Shaft 76 is retained in housing 40 by an opposed set of tapered roller bearings. The housing is machined so that upper bearing assembly 60 and lower bearing assembly 62 are rigidly held in place. Bearing assembly 60 is held in place by shim 58 as it is locked into place on the shaft by rotary hydraulic coupling 51. The coupling is larger in diameter than the top of shaft 76 and is held onto the shaft by two bolts 46. The shaft and the coupling are held in alignment with one another by matching mating surfaces 59. Passage O-rings 52 seal the fluid passages of the rotary coupling to the fluid passages in the shaft. Grease seal 64 keeps dust and foreign material out of the housing.

Hydraulic swivel sleeve 50 creates two separated annular channels 57 when it is in place around the rotary hydraulic coupling. O-rings 52A separate the channels from one another and seal the upper and lower edges of the channels. O-rings 52A are slightly compressed into their seats by the snug fit of the swivel sleeve around the coupling. Oil seals 53 keep dirt and dust out of the inner surfaces of the swivel sleeve by sealing the gaps at the top and bottom of the sleeve. The sleeve is retained on the rotary coupling by cap 56 which rotates along with the shaft, the coupling, and the bolts that hold the cap and coupling onto the top of the shaft. The sleeve and the housing do not rotate. Hydraulic hoses 44P and 44R, which are attached to fluid ports 55P and 55R on the sleeve, remain in a stationary position.

Any hydraulic fluid that enters fluid port 55P under pressure is conducted through the port and into annular channel 57P. The fluid is then free to flow around the channel in either direction around the perimeter of rotary hydraulic coupling 51 and into hydraulic fluid passage 54P with which it is connected. The pressurized fluid is then forced downward through the section of hydraulic fluid passage 54P that interfaces with hydraulic fluid passage 54P which continues downward through shaft 76. The flow of pressurized fluid continues to be conducted through the same hydraulic fluid passage whether the shaft is rotating or not. The shaft may also rotate in either direction and the flow of pressurized fluid will continue through the same fluid passage. The flow of hydraulic fluid may be reversed selectively by auxiliary hydraulic control 21 located on the motive source. When the flow is reversed the pressure side of the hydraulic system becomes the return side. The flow of pressurized hydraulic fluid throuth the shaft is a means of conducting pressurized hydraulic through the pivotable connection between the support structure and the adjustable frame.

The shaft is integrally connected to tee bar 77. The tee bar journals rocking pin 82. The rocking pin is also journalled by midpoint sleeves 85F and 85R so that adjustable frame 86 is pivotally connected to the tee bar by the rocking pin. Retainer bolt 84 keeps the rocking pin in position. The interconnection of the shaft and tee bar to the adjustable frame is a second means of pivotably connecting the support structure to the adjustable frame, allowing the adjustable frame to rotate about a somewhat horizontal, first horizontal axis. The adjustable frame pivots on an axis that is perpendicular to the shaft. This axis always remains perpendicular to the shaft. Every component of the invention that is interrelated or connected between the rocking pin and the skidsteer, including the skidsteer, rotates, in relation to this axis, independently of the remaining components of the invention. The axis of rotation of rocking pin 82 changes orientation as the shaft rotates within housing 40.

Adjustable frame 86 keeps the axis of the rocking pin perpendicular to the axis of rollers 100. The axis is also perpendicular to scraper blade 96 as the adjustable frame connects tool carrier assembly 92 to the rocking pin. The adjustable frame is pivotally connected to wing tip carrier bushings 91 which are integrally attached to the tool carrier assembly and to cross member 121. These two connection points are located forward of the scraper blade adjacent to the end plates. Wing tip pins 88, are journalled by wing tip sleeves 90, and also by the wing tip carrier bushings. Struts 87 integrally connect the mid point sleeves to the wing tip sleeves. The adjustable frame is indirectly connected to the tool carrier assembly by pivotable connections to ram 115. Ram base 114 is pivotally connected to tab 113 by clevis pin 112. The tab is an integral part of mid-plate 106. Ram rod 116 is pivotally connected to the adjustable frame by ram pivot pin 117. The ram pivot pin is held in position by retaining clip 118. The hydraulically controlled ram allows the tool carrier assembly to be adjustably held in relation to the adjustable frame, as the adjustable frame pivots about the somewhat horizontal, third horizontal axis. The wing tip pins, sleeves, and bushings, along with the ram and the connection between the ram, the adjustable frame and the tool carrier assembly, are a means of pivotable connection that allows the adjustable frame to rotate controllably about a somewhat horizontal, third horizontal axis.

The hydraulic fluid to control the ram flows through the channels in shaft 76. Hydraulic fluid passage 54P is the pressurized channel in the shaft and hydraulic fluid passage 54R is the return channel in the shaft. Tool carrier hose 65P connects to service port 66P on shaft 76. Tool carrier hose 65R connects to service port 66R on shaft 76. Tool carrier hose 65P is connected to the fluid port at the base of the ram. Hydraulic fluid that enters this port under pressure forces the ram rod to extend. Tool carrier hose 65R is connected to the fluid port nearest the ram rod end of the ram. Fluid exits the port near the ram rod end of the ram, as the ram rod extends, through tool carrier hose 66R. The return flow of hydraulic fluid continues into shaft 76 through service port 66R.

Auxiliary hydraulic control 21 is activated on demand to allow the flow of pressurized hydraulic fluid out of the hydraulic fluid pressure connection 28 and the return of an equal amount of hydraulic fluid into hydraulic fluid return connection 29 on the skidsteer. The pressurized fluid travels through the sealed hydraulic system and into ram 115. As ram rod 116 extends to its full length the flow of the pressurized hydraulic fluid stops. Auxiliary hydraulic control 21 may then be switched to the reverse flow position to allow hydraulic fluid to surge through the sealed hydraulic system in a reverse flow direction and in so doing forces the ram rod to be retracted into the ram. In this way the ram may be lengthened or shortened on demand by the use of auxiliary hydraulic control 21.

The change of length of the ram causes a significant change in the depth of cutting edge 94. The cutting edge is integrally attached to and works in conjunction with scraper blade 96, when the invention is engaged in work. As the ram is lengthened the cutting edge rises up off of the surface being worked. As the ram is shortened the cutting edge digs more deeply into the surface being worked. This change in length of the ram causes the cutting edge to rotate around an arc that is formed by the cutting edge as it rotates around the axis about which a pair of rollers 100 rotate. The cutting edge is the leading edge of the tool carrier assembly. The depth of the cutting edge and scraper blade can be controlled by the activation of auxiliary hydraulic control 21 to shorten or lengthen the ram. This second means of depth control causes the cutting edge and scraper blade to raise or lower from the surface being worked. The depth of the cutting edge and scraper blade can also be controlled by tilt mechanism 26, a previously mentioned first means of depth control, while the motive source is moving in a forward or backward direction.

The pair of rollers 100 are the trailing component of the tool carrier assembly. They are removably attached to the end plates and the mid-plate. They are held in place by an eyebrow stop 99 that is integrally attached to each of the plates on the inboard side of the end plates and both sides of the mid-plate. The rollers comprise; the ground contact surface, discs 119, and axle 104. The rollers may be exchanged for an alternate set of rollers as the working conditions require. The ground contact surfaces can have a variety of features that perform various functions. Rubber would function well on concrete or other delicate surfaces. Studs would break up the surface being worked. A roller with bars would break up lumps in the surface being worked. The disks create a rigid support structure that is integrally attached to the axle.

The roller bearing carrier assembly comprising; hub 103, sliding collar 105, set screw 107, two axle roller bearing assemblies 108, two snap rings 123, locking tang 109, hub nut 110, dust cover 111, and set screw 107A, is mounted on the axle. The roller bearing carrier assembly is a means to attach the rollers to the plates and allow the roller to rotate about a somewhat horizontal, second horizontal axis. It accomplishes this by nesting the hub into the bottom side of the eyebrow stop, and sliding the collar over the outer circumference of the eyebrow stop and a bottom portion of the hub. The collar slides into position over the eyebrow stop from its position on the hub to hold the roller in place in the tool carrier assembly. The set screw secures the sliding collar and prevents it from sliding off of the eyebrow stop. The snap rings hold the bearings in place within the, hub. The locking tang prevents the nut from coming off the threaded end of the axle. The nut keeps the hub on the axle. The dust cover keeps the bearings clean. Set screws 107A secure the dust cover to the hub. The bearings allow the axle to rotate within the hub as the hub is held in place by the sliding collar.

Ground contact surface 101 of the rollers flattens the surface being worked and supports the weight of the grader while it is engaged in work. Additional downward force may also be applied to the rollers by lifting the front wheels of the skidsteer off the ground. The front wheels are lifted by retracting the lift arm rams completely so that the lift arms are in the full downward position. With the front wheels of the skidsteer lifted off the surface being worked, the skidsteer can turn in a very short turning radius in a cyclonic or anti-cyclonic motion. While turning the skidsteer in this manner, the tool carrier assembly casters and changes its orientation. The cutting edge becomes parallel with the support structure. Even though the orientation of the tool carrier assembly changes, the position of the cutting edge, scraper blade, and the axis about which the rollers rotate does not change.

The tool carrier assembly rolls over the surface being worked in response to the movement of the motive source. Cross members 120 reinforce the tool carrier assembly. The tool carrier assembly casters in response to a turning motion or change of direction of the motive source. As the tool carrier assembly pivots around a somewhat vertical axis the scraper blade remains at the leading edge of the tool carrier assembly. The cutting edge prevents the scraper blade from bending and screeds off the material being worked. With the cutting edge near the level of the surface being worked any high spots in the surface being worked are sliced off by the cutting edge and the excess material tends to build up on the leading side of the scraper blade. The rollers function not only as a means of ground support but also as a means of providing a depth guide as they contact the surface being worked. As the tool carrier assembly continues forward, urged on by the motive source as it moves in any direction, the trailing rollers ride on the screeded surface and maintain the cutting edge and scraper blade at a consistent height even though they may be passing over a depression or hole in the surface of the material being worked. A portion of the excess material being worked that is being pushed along the leading edge of the scraper blade, is deposited into the depressions or holes in the surface being worked.

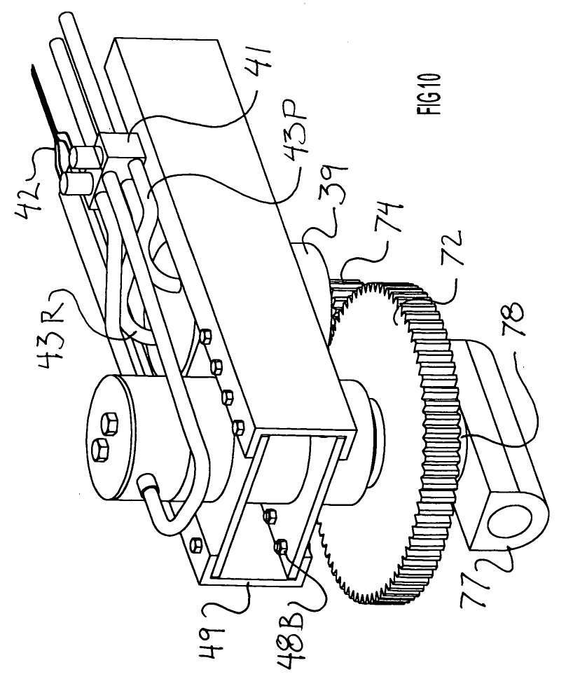

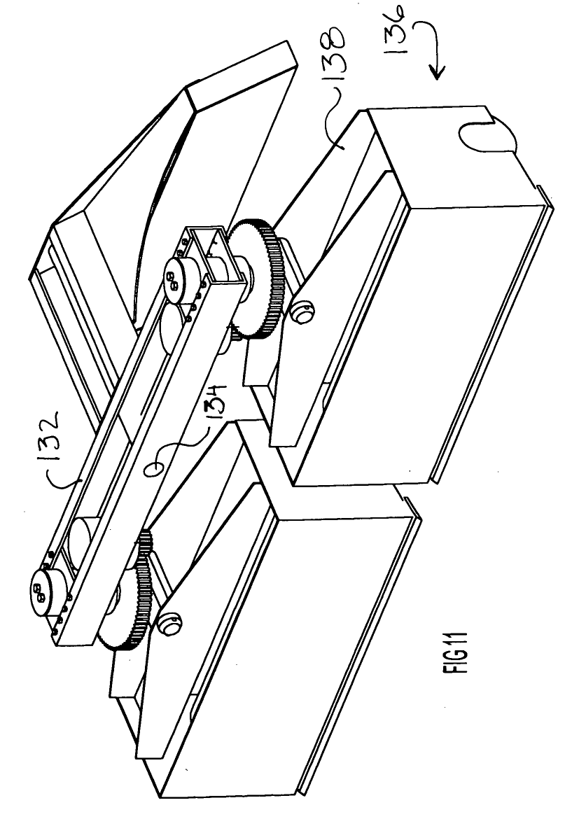

FIG. 10—Description of Hydraulic Motor and Gear Drive

The alternative embodiment comprising, the motive source, the support frame, the housing, a power shaft 78, the rotary hydraulic coupling, the adjustable frame, the tool carrier assembly, and all of the connections between these components as set forth in the preferred embodiment, a hydraulic motor 39, a solenoid activated hydraulic valve 41, a motor hose 43P, a motor hose 43R, a retaining clamp 68, a key 70, a primary gear 72, and a drive gear 74.

Power shaft 78 of the alternative embodiment is identical to shaft 76 at all the connection points with other components of the preferred embodiment. It is identical at all surfaces of interrelation with other components. Shaft 78 is longer than shaft 76. Hydraulic fluid passages 54P and 54R are longer by the same distance. Shaft 78 has a key-way 79 cut into the shaft in a vertical orientation a predetermined distance below housing 40. The key-way is cut into the shaft on the opposite side of the shaft in the same vertical orientation. A clamp seat 67 is cut into shaft 78 at the upper edge of the key-ways. Two seats are cut around the entire circumference of the shaft in an annular orientation. The distance between the clamp seats is identical to the thickness of primary gear 72.

Primary gear 72 has a center hole with a diameter that is slightly larger than the diameter of the uncut surface of power shaft 78. Retaining clamp 68 is removably attached to the shaft at the clamp seat. A key has a rectangular shape and has dimensions that corresponds with the key-way. The gear has two key-ways cut into the center hole that are opposite one another. The primary gear has evenly spaced teeth on its outer perimeter. The teeth on the primary gear interface with teeth on drive gear 74. The drive gear is attached to hydraulic motor 39.

Hydraulic motors are well known in the art. The hydraulic motor has motor hose 43P connecting it to solenoid activated hydraulic valve assembly 41. Motor hose 43R connects the motor to the valve also. The valve is connected in line to pressure hydraulic hose 44P and pressure hydraulic hose 44R. A control wire harness 42 connects the solenoid to the electrical system of the motive source.

FIG. 10—Operation of Hydraulic Motor and Gear Drive

The components of the preferred embodiment are present in this alternate embodiment and function in the same way in this embodiment.

Power shaft 78 is longer to allow for the thickness of gear 72. The power shaft may be given rotational energy that is translated through primary gear 72. The gear is held horizontally in place on the vertical shaft by the retaining clamps. The keys prevent the gear from rotating, in relation to the shaft, when installed on the shaft. The teeth on the outer perimeter of the primary gear engage teeth on drive gear 74. The drive gear is given rotational energy by hydraulic motor 39 which is secured to main body 37.

The hydraulic motor is well known in the art. The hydraulic motor is reversible and is controlled by the flow of hydraulic fluid through solenoid activated hydraulic valve assembly 41 connected to the hydraulic pressure and return hoses set forth in the preferred embodiment. The valves direct the flow of the hydraulic fluid and are opened or closed by solenoid valve 41 which is activated electronically, a means of power activation. A control wire harness connects the solenoid to a the electrical system of the skidsteer. Motor hose 43P connects the control valve assembly to the motor. When the hydraulic fluid is directed through hose 43P, it passes through the motor and imparts rotational energy to the drive gear. The fluid then is directed into hose 43R and returns to the control valve assembly. The direction of flow of the hydraulic fluid may be reversed by the auxiliary hydraulic control on the skidsteer. In this mode of operation the shaft and tool carrier assembly are given rotational energy independent of that given by the movement of the motive source. The tool carrier assembly can be positioned in this way in any desired degree of rotation around the vertical axis of the shaft. The auxilliary hydraulic pump, the controls that activate the flow of pressurized hydraulic fluid, the fluid passages and hoses, the hydraulic motor, the gears given rotational energy by the hydraulic motor, the shaft, and all the associated connections between these components are a means of conveying rotational energy to the tool carrier assembly, thereby allowing it to rotate about the somewhat vertical axis.

The valves may also direct the flow of fluid through the motor in a bypass route that is isolated from the rest of the pressurized system. This bypass position of the valves would result in the relatively free rotation of the shaft as set forth in the preferred embodiment. In the bypass mode of operation no rotational energy would be generated by the motor.

By selectively opening or closing the appropriate valves within the valve assembly, fluid can be prevented from flowing through the motor and cause a braking effect, a means of resisting the rotation of the shaft and tool carrier assembly. In this mode of operation the tool carrier assembly would not be free to rotate around the vertical axis of the shaft.

FIG. 11—Description of Multiple Tool Carrier Assemblies

The alternative embodiment comprising; the support structure of the preferred embodiment, an equalizer frame 132, an equalizer pin 134, a frame adapter, a single roller tool carrier assembly 136, rollers 100, eyebrow stops 99 and roller bearing carrier assemblies 102.

The equalizer frame is an elongated beam of identical cross section as the main body of the support frame. This allows housing 40 to be attached to it according to the invention. At the midpoint of the equalizer frame there are bushings that journal an equalizer pin. The equalizer pin is journalled transverse to the length of the equalizer frame. The equalizer pin is connected to a fame adapter which is connected to the distal end of the main body. The equalizer frame is connected to the flange of housing 40 by bolts.

The housing, shaft, motor, gears, rocking pins, eyebrow stops, roller bearing carrier assemblies and all of the connections between these components are the same as set forth in the preferred embodiment. The hydraulic hoses from the skidsteer are both connected to a tee fitting to supply the fluid power for the motors.

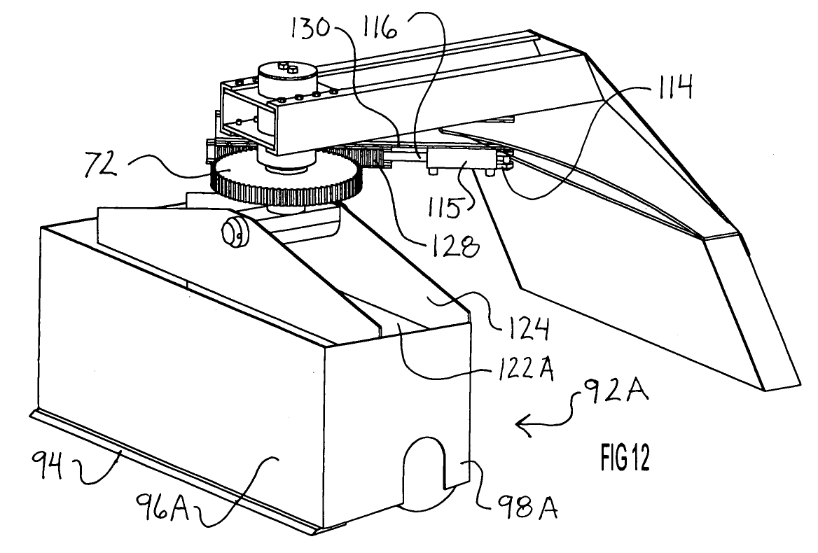

The single roller tool carrier assembly is like the tool carrier of FIG. 12 with one exception. The single roller carrier is half the width of the basic tool carrier assembly. There is no mid-plate on the single roller carrier, only two end plates. A half size mounting plate 138 of the single roller tool carrier is half the length of the basic tool carrier assembly. The connections between the half size mounting plate and the single roller carrier are the same as are the connections to the rocking pin, according to the invention.

FIG. 11—Operation of Multiple Tool Carrier Assemblies

The support frame functions as in the preferred embodiment. Equalizer frame 132 pivots on a horizontal axis that is parallel to, and centered between, the beams that extend outward to the distal end of the support structure. The equalizer pin is journalled at the midpoint of the equalizer frame. The frame adapter pivotally attaches equalizer pin 134 to the support structure. The flanges attached to the housing connect to the ends of the equalizer frame. The housing journals the shaft. The half size mounting plates function the same as the mounting plates.

The equalizer frame pivots in response uneven terrain or the rocking motion of the motive source as it traverses bumpy surfaces.

The single roller tool carrier assemblies function the same as the basic tool carrier assembly in FIG. 12. The single roller carriers may be pivoted around a vertical axis by the selective engagement of the auxiliary hydraulic control. The fluid travels through the hoses from the skidsteer.

The housing, motors, gears, rocking pins, eyebrow stops, roller bearing carrier assemblies and all the connections between them function the same way as set forth in the preferred embodiment.

FIG. 12—Description of Rack and Gear

An alternative means of conveying rotational energy to dry shaft 80 is set forth in this embodiment of the invention. A rack gear 128 is a linear bar with gear teeth on one side. The opposite side of the rack gear is wider than the width of the teeth on the opposite side. The rack is of sufficient length to allow the teeth to interface with primary gear 72. One end of the rack is integrally connected to the end of ram rod 116. The rack is a linear extension of the ram rod. The rack and the ram are retained in a slide channel 130. The slide channel has a “C” shaped cross section. The slide channel is pivotally attached to the main body of the support frame at the midpoint of the slide channel. Ram base 114 is attached to the proximal end of the slide channel. The distal end of the slide channel is pivotally connected to a cam lock mechanism. The cam lock mechanism is attached to the distal end of the support frame. The cam lock mechanism is pivotally connected to a rod that extends to the proximal end of the support frame. Pressure hose 44R is connected to one of the fluid ports on ram 115. Pressure hose 44P is connected to the other fluid port on the ram.

FIG. 12—Operation of Rack and Gear

This alternative embodiment of the invention provides for a means of imparting rotational energy to the tool carrier assembly through dry shaft 80 through primary gear 72. The primary gear is given the rotational energy by engagement and movement of rack gear 128. The rack gear is moved by the action of ram rod 116 as it is extended or retracted by ram 115. The rack gear and the ram are retained by slide channel 130. The ram rod is powered by the flow of hydraulic fluid from the skidsteer through pressure hose 44P and pressure hose 44R. The flow is controlled by the auxiliary hydraulic control of the skidsteer. The flow may be reversed by the selective control or the flow may be stopped as a means to effectively stop the rotation of the dry shaft and the interconnected parts, including the tool carrier assembly. The tool carrier assembly according to the invention will rotate around the vertical axis of the dry shaft in response to the auxiliary hydraulic control of the skidsteer. A separate set of valves in the control valve assembly may be positioned so that the ram is locked into position by preventing the flow of hydraulic fluid to the ram.

The slide channel can be pulled away from the primary gear so that the rack gear disengages from the primary gear. This disengagement allows the dry shaft to rotate freely about the vertical axis of the dry shaft in response to the motion of the skidsteer. The disengagement is caused by the action of a cam as it rotates around an axis at its point of attachment to the distal end of the support frame. The sliding channel is pivotally attached to the cam lock mechanism and as the cam is rotated the sliding channel pulls away from the primary gear. The cam is rotated by a rod that is pivotally connected to it and is manually pushed in or pulled out by the operator of the skidsteer as a means to engage or disengage the transmission of rotational energy translated to the tool carrier assembly. The slide channel is pivotally connected to the support structure near its midpoint allowing the movement of the cam at its distal end to pull it away from the primary gear.

FIG. 12—Description of Basic Tool Carrier Assembly

In this alternative embodiment a tee bar 77 is connected to a tool carrier assembly 92A in the same manner as set forth in FIG. 14—description of simple adjustment tool carrier.

In FIG. 12 the tool carrier assembly is comprised of; cutting edge 94, eyebrow stop 99, roller bearing carrier assembly 102, rollers 100, and cross members of the preferred embodiment.

The elements of the alternative embodiment of basic tool carrier assembly 92A that are different than that of the preferred embodiment comprising, a vertically oriented scraper blade 96A, an end plate 98A, a second end plate 98A, an alternate mid-plate, a back plate 122A, and alternate cross members.

The scraper blade is an elongated vertically disposed surface whose bottom margin is attached to cutting edge 94. The cutting edge and scraper blade are integrally attached to one another and also to the leading edge of end plates 98A.

The point of attachment of the end plates and the cutting edge is at the bottom edge of the end plate at a height level with a point between the bottom of the rollers and the center of the axles. The end plates lie within a vertical plane that is perpendicular to the vertical plane of the scraper blade. The end plates are integrally attached to mounting plate 124. The end plates are integrally attached to back plate 122A along the trailing vertical edge of the end plate.

The alternate mid-plate lies on a vertical plane that is parallel with the end plates and is integrally attached to the scraper blade at its leading vertical edge. The intersection of the vertical plane of the scraper blade and the vertical plane of the mid-plate is the point of attachment of these two components of basic tool carrier assembly 92A. The mid-plate is integrally attached to the back plate at the intersection of the two components at the intersection of their respective planes.

FIG. 12—Operation of Basic Tool Carrier Assembly

This alternative embodiment is connected to the tee bar. The tee bar pivots on mounting plate 124. The cutting edge, the eyebrow stop, the roller bearing carrier assembly, rollers and cross members function according to the preferred embodiment.

The rigid box-like structure of basic tool carrier assembly 92A is created by the end plates, mid-plate, back plate and cross members functioning together to hold the cutting edge and scraper blade in a fixed relationship with the axis of the rollers. The height of the cutting edge from the surface being worked is determined by the tilt of the tilt mechanism of the skidsteer and the height of the lift arm assembly.

In FIG. 12 the basic tool carrier assembly is oriented so as to push soil ahead of the scraper blade as the skidsteer moves in a forward direction. In this mode of operation the cutting edge would be lowered as the tilt mechanism is rotated in a top forward motion. The forward tilting of the tilt mechanism is translated through the support frame and causes the shaft to tilt forward. This tilt forward in the push mode causes the cutting edge to rotate forward around the axis of the rollers and to cut deeper into the surface being worked. A the grader rides on the rollers the depth of the cut of the cutting edge is controlled. This tilting action also causes the front wheels of the skidsteer to rise. If the lift arms of the skidsteer are raised, the front wheels of the skidsteer will be lowered to any desired height off the surface being worked. If the lift arms are raised past the point of front wheel contact with the surface being worked, the grader will be disengaged from the surface being worked.

The tool carrier can be rotated to operate in a pull mode with the skidsteer moving in a reverse direction. In this mode of operation a forward tilt of the tilt mechanism causes the opposite effect on the cutting edge. The tilting of the mechanism in either direction has a direct effect on the height of the cutting edge off the surface being worked.

The height of the cutting edge during cyclonic motion of the skidsteer will return to level as the orientation of the axis of the rocking pin nears the horizontal position.

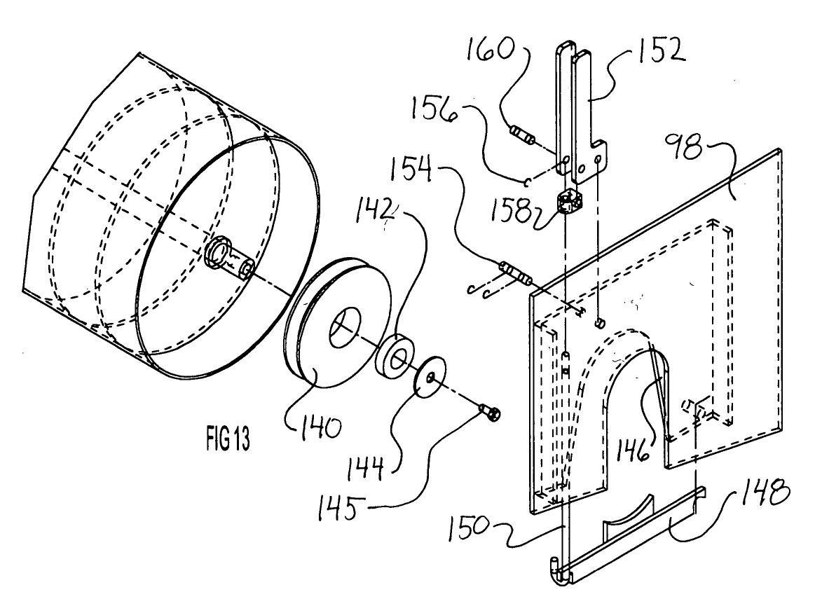

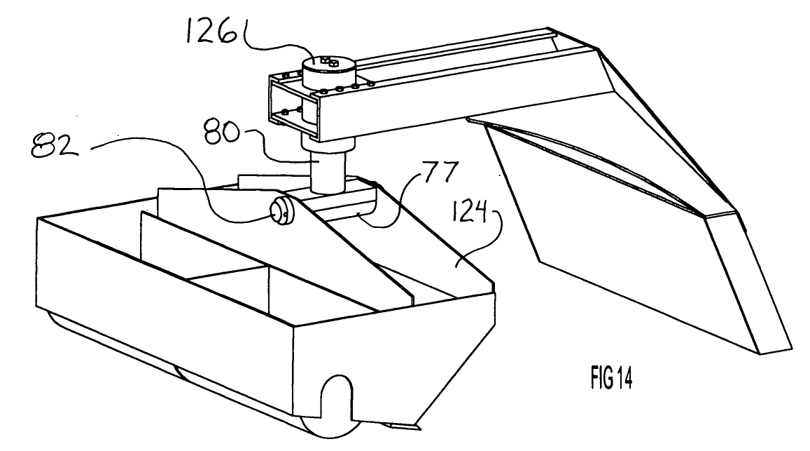

FIG. 13—Description of Pulley Mounted Axle

The end plates and mid-plate as set forth in the preferred embodiment are integrally attached to an inner mount 146 of this alternative embodiment. The plates are integrally connected to the appropriate components of the tool carrier assembly of the preferred embodiment. An axle 104A of this alternative embodiment extends past the end of the ground contact surface. A pulley bearing 142 is a tapered roller bearing that has an inner race that is shaped to fit the machined surface of the end of the axle. The outer circumference of the pulley bearing fits snugly into a pulley. The bearing is retained on the axle by a washer 144. The washer is held on the axle by axle bolt 145. The axle is integrally attached to the disks of the rollers. The remaining components as described in the preferred embodiment are the same as in this alternative embodiment.

The inner mount has a surface that is parallel to the end plates and the mid-plate and a thickness that matches the bottom of the groove of a pulley 140. The inner mount is essentially rectangular in shape with an A shaped cutout along the bottom edge with the open end of the A facing downward. The apex of the cutout is rounded and aligned on all of the plates. The inner mount is integrally connected to the plates at the forward and aft edges of the inner mount by rectangular strips that are integrally connected to both the inner mount and the plates. The rigid rectangular strips space the inner mount a distance from the plates that allows the rollers to fit between the inner mounts of the tool carrier assembly. The inner mount is also integrally attached to the end plate by a horizontal rod that supports a locking arm 148.

Locking arm 148 has a surface that matches the bottom of the groove of the pulley. At the opposite end of the locking arm from the rod that integrally connects the inner mounting plate to the end plate or mid-plate, there is an upward facing pivot able connection point. A hook 150 is attached at this second pivot able point.

The hook has an eye on the lower end and an elongated dowel that extends upward and terminates at an end that is threaded.

A block 158 has a hole in it that is threaded to match the threads on the upper end of the dowel. The block has a second hole that is perpendicular to the first hole in the block. The first hole is somewhat vertical and the second somewhat horizontal, and the diameter of both holes are the same. A lever pin 154 is a circular rod that has a diameter that equals the diameter of the holes in the lever.

The lever pin has a length that equals the distance between the inner mount and the end plate, plus the thickness of the inner mount and the thickness of the end plate. A snap ring 156 is locked into grooves on the lever pins. The outer edge of the grooves are a distance from the ends of the pins that matches the thickness of the end plate and inner mount.

A lever 152 is a plate in the shape of an L. There are two holes in the bottom of the L. Lever pin 154 has a diameter that matches that of the holes in the lever. The holes are aligned on a line that angles upward from a point near the lower left hand outside angle of the L shape. The left side hole is closer to the bottom of the L than the hole on the right side.

Block 158 has a width that is less than the distance between the inner mount and the end plate minus the thickness of, two levers and two snap rings. A block pin 160 is shorter than the lever pin by a distance that equals the thickness of the end plate and the inner mount. The block is pivotally held in place between two levers by the block pin which fits into the holes in the levers that are closest to the bottom margin of the base of the L. The snap rings fit into grooves between the block and the inner surfaces of the levers. The block pins are flush with the outside of the levers.

FIG. 13—Operation of Pulley Mounted Axle

The pulley fits into the cutout in the inner mount. As the tool carrier is lowered onto the roller the edges of the inner mounts seat into the center groove of the pulleys. The pulley is locked into place by the locking arm. After the pulleys are seated into the mounts the locking arm is hung on to the horizontal rod that is integrally attached to both the mount and the plate. A surface on the locking arm seats into the groove in the pulley. The locking arm is forced upward into the groove of the pulley with such force as necessary to hold the roller into place. The end of the locking arm that is opposite the one cradled by the horizontal rod has a surface to cradle the hook on it. The hook is oriented so that the eye on the bottom of the hook pulls upward on the locking arm as it is pulled upward by the levers. The threaded end of the hook is threaded into the block and adjusted to the proper length so that the lever can be rotated and the lever is locked into place.

The block keeps the levers separated so that the hook can contact the lever pin as it is locked into position. The block pin is secured to the block by the two snap rings that are installed between the levers and the block. The snap rings prevent the pin from sliding from side to side. The lever pin allows the levers to rotate to lock or unlock the locking arm into the groove of the pulley.

The pulley bearing allows the pulley to rotate on the axle in either direction. A shoulder on the axle keeps the bearing in place and prevents side shifting of the axle. The washer and bolt keep the pulley on the axle. The pulley mounting system is a means of removably attaching the rollers to the tool carrier assembly.

The roller functions the same in this alternative as it does in the preferred embodiment.

FIG. 14—Description of Simple Adjustment Tool Carrier

An alternative embodiment comprising; the motive source, support frame, housing, and all the connections between them as set forth in the preferred embodiment of the invention and is further comprised of the following.

The tool carrier assembly of this embodiment of the invention has a mounting plate 124 on a vertical plane, which is integrally attached to the end plates of the tool carrier assembly. The plane is parallel with the cutting edge. There is a second mounting plate integrally attached to the end plates in a second vertical plane which is parallel to the plane of the other mounting plate. The two mounting plates are separated by a distance that is equal to the length of the tee bar which is integrally connected to a dry shaft 80.

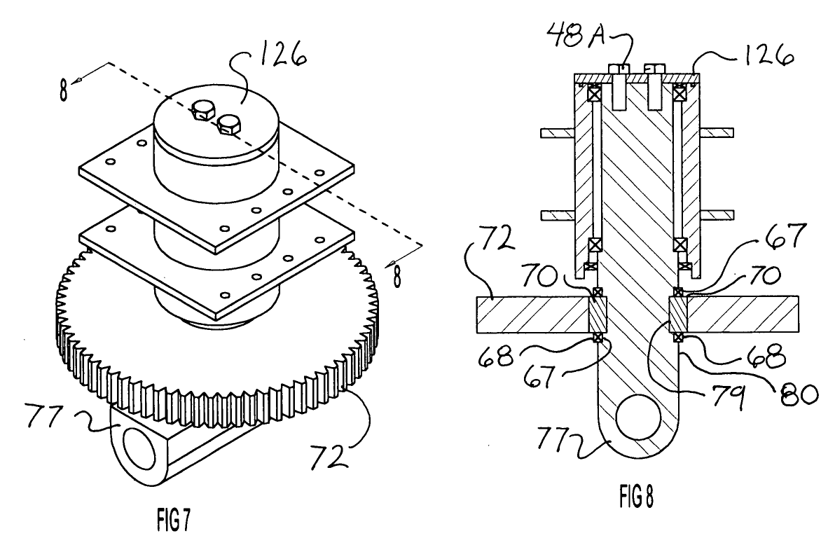

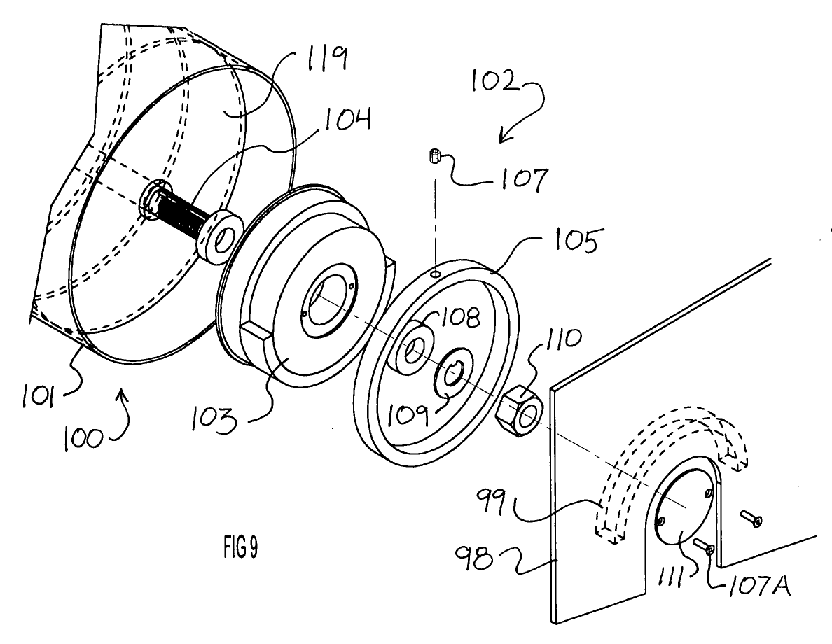

The dry shaft is identical to power shaft 78 in its exterior dimensions. A dry shaft cap 126 is cylindrical shaped with a top surface that is perpendicular to the sides of the cylinder. The diameter of the dry shaft cap is the same as the diameter of the housing. Oil seal 53 is seated between the top of housing 40 and the bottom of the dry shaft cap. A female mating surface is formed on the bottom of the dry shaft cap. The two holes that are vertical through the dry shaft cap are aligned on a vertical axis that bisects the center of the dry shaft cap. Dry shaft cap 126 is secured to the dry shaft by bolts 46. The bolts extend downward into threaded holes in the dry shaft. FIGS. 7 and 8 show the dry shaft in detail with the primary gear on the shaft. In this alternative embodiment the gear may be on the shaft or it may be absent.

Rocking pin 82 connects the tee bar to the mounting plates. The rocking pin is journalled by bushings that are integrally attached to the mounting plates at the center of the mounting plates. The rocking pin is retained in place by retainer bolt 84.

FIG. 4—Operation of Simple Adjustment Tool Carrier

The motive source, support frame, housing, and all the connections between them as set forth in the preferred embodiment function the same in this alternative embodiment as they do in the preferred embodiment. The bearing assemblies, oil seals, and shim function the same in the alternative embodiment set forth here as the do in the preferred embodiment. Dry shaft 80 is rotatable on a vertical axis as set forth in the preferred embodiment for the function of shaft 76.

Dry shaft cap 126 functions to retain the dry shaft in the housing. Bolts 46 secure the dry shaft cap to the dry shaft. The dry shaft is integrally connected to the tee bar as set forth in the preferred embodiment of the invention. Tee bar 77 and rocking pin 82 are connected to mounting plate 124, allowing the tee bar to pivot around an axis that is centered on the rocking pin. The pair of mounting plates have bushings integrally attached to them to journal the rocking pin. The tool carrier assembly of this embodiment casters in response to the movement of the motive source as set forth in the preferred embodiment. The tool carrier assembly of this alternative embodiment has all of the components set forth in the preferred embodiment. The tool carrier assembly is connected to the rocking pin in such a way that the mounting plates do not move in relation to the tool carrier assembly. The height of the cutting edge of this alternative embodiment is controlled by tilt mechanism 26 of the motive source and by raising or lowering lift arm assembly 22.

The motive source is able to lift the front wheels of the skidsteer off the surface being worked to enable turning without a disengagement of the tool carrier assembly from the surface being worked. Cyclonic and anti-cyclonic motion of the motive source is caused by the selective control of the left side wheels of the skidsteer in one direction and the right side wheels in the opposite direction. The opposing directional forces of the wheels of the skidsteer are a means to allow a short turning radius to be used in the performance of the work upon demand

### Conclusion, Ramifications, and Scope of Invention

Accordingly one will see that the skidsteer loader is made even more valuable by the creation of a grader that overcomes a negative aspect of the skidsteer, namely the disruptive effect of the turning process, and turns it into a positive feature by combining the two and essentially making a zero turning radius grader. With the front wheels of the skidsteer lifted off the ground, the grader casters on the rollers in response to the turning action of the skidsteer and can turn in a cyclone like way around the skidsteer.

While my above description contains many specificities, these should not be construed as limitations on the scope of the invention, but rather as an exemplification of one preferred embodiment thereof. Many of the alternative embodiments previously presented could be used in many different combinations. Many other variations are possible. For example, with a few modifications such as a cover over the top of the tool carrier assembly and a hydraulically operated beater attachment the grader could be converted for use as a mine sweeping device that clears a battle zone of unexploded mines. The invention textures the soil so that the operator can tell where the device has already passed over an area being cleared. The invention could easily be used by an armored track type vehicle in the same way it is used with a skidsteer and with the added maneuverability it would make the process of mine clearing much faster.

Cultivation tools that are powered by a hydraulic motor could be added to the tool carrier as a means to allow the grader to cultivate and loosen the soil. These could be lowered to the ground on a pivoting set of arms to engage the tool on demand or retracted to a resting position up and out of the way to permit simply leveling the soil. The cultivation tools could be on a rotating drum or a set of rototiller tines on a shaft. The cultivator tools could be engaged by an eggbeater type of action. A set of disks could be lowered to contact the earth. Many of the ramifications could be lowered into place manually with a screw type connection link or they could be positioned by inserting a pin in part of the structure to secure the tools into place.

The rollers could have many different types or textures of ground contact surfaces on them. A surface made up of scrap rubber tire pieces could be attached to the outer contact surface in a variety of ways so that the grader could roll onto concrete walks and driveways without doing any damage. A flat roller with studded surfaces on it could be used to texture the ground as the rollers pass over the surface. A surface made up of disks or plates spaced apart could effectively break up the lumps in a soil surface thereby preparing for seed. A series of evenly spaced spiraling bars at the surface could function nicely as a crumble roller.

The support structure of the invention could be constructed in many different shapes. It could be a lower profile with a short shaft. A variety of gussets and braces could be added by one skilled in the art. Cutouts for better visibility could be strategically located at various pints on the distal end of the support structure. The main body cold be shaped by a variety of different shapes structural members. Round pipes or rectangular materials could be used. Many different types of braces, reinforcement, or gussets could be added for structural integrity.

The flanges on the housing could be integrally cast in one piece with the housing. The internal components of the housing could be sized differently and many arrangements of bearings would successfully accomplish the task of journalling the shaft in the housing. The bearing surface could be a simple brass bushing that is greased with a king pin held in place. One skilled in the art would be able to conjure uncountable variations for journalling the shaft in the housing. The housing could be replaced by a pair of flat plates that function as bearing surfaces with roller bearings in between. The adjustable frame could then be attached directly to attachment points on the bottom plate and the top plate could then be attached to the support structure.

Hydraulic hoses or metal lines in a hollow shaft could pass through the center to the tool carrier. The hydraulic swivel could be a separate component. The shaft could be larger, shorter, longer, or smaller or could have more than two channels running through it for hydraulic fluid. The method of connection to the tee bar could be a removable connection such as a flatted cast piece that fits over a flatted end of the shaft. The tee bar could be a different shape altogether. Instead of one long rocking pin, there could be two short ones in a U shaped component connecting the shaft to the adjustable frame. There could be many different variations of reinforcing the connection of the tee bar to the shaft.

The gear on the shaft could be replaced by a sprocket given rotational energy by a chain connected to a sprocket on the drive mechanism of the motor. The motor driving the gear or chain could be an electric motor. The motor could be mounted in a variety of locations on the support structure. The gear or sprocket could be located on top of the shaft. Belts could also be used to power the shaft. The gears could be sized in many different combinations to change the speed of rotation of the tool carrier assembly. There are a variety of ways to secure the gear onto the shaft. The shaft could be flatted to fit a corresponding flat on the gear. The shaft could have splines that fit on corresponding surfaces on the gear or sprocket.

The adjustable frame could be many different shapes. It could be a lower profile, or it could be attached to the tool carrier closer to the center of the tool carrier. It could have an arched shape or it could be rectangular in shape. Many different shapes of gussets and reinforcing plates could be used. It could be attached to the tool carrier in many ways. It could be farther forward of the scraper blade or it could be connected to the tool carrier aft of the scraper blade. The adjustable frame could be adjusted in different ways. A scissors frame could turn on opposed screws like a scissors jack to raise or lower one side or the other of the rocking pin bushing to give the shaft a different tilt with respect to the draft of the cutting edge. The adjustable link to an adjustable frame could be a turnbuckle, or some type of ratcheting mechanism.

The tool carrier assembly could be a different shape. The rollers a different diameter, the cutting edge at a different angle, the braces in a different place, more mid-plates, no mid-plate, one roller, a set of wheels and tires instead of rollers, more than one ram, or more than one manual connecting link to the adjustable frame.

The tool carrier could have a depth gage indicator between the adjustable frame and the tool carrier assembly. This could be a rod with markings on it, sliding within a hollow tube, that is pivotally connected at one end to the tool carrier. The tube could be pivotally connected to the adjustable frame and the action of adjusting the attitude of the frame to the tool carrier would cause the rod to slide within the tube thereby indicating the depth of the cutting edge. The depth indicator could also be a circular disk with a square hole in the middle of it and a square rod that fits in the hole in the middle of the disk. The square rod is twisted to create a somewhat spiral effect of the points of the angles on the surface of the rod. These spiraled edges would cause the disk to spin at a predictable rate as the rod is pushed through the hole in the disk. The disk could be pivotally connected to the adjustable frame and the square rod to the tool carrier.

The rollers could be attached to the carrier by simple flange mounted bearing.

Accordingly, the scope of the invention should be determined not by the embodiments illustrated, but by the appended claims and their legal equivalents.

I claim:

1. a method of moving an earthworking tool about a surface in situ comprising the steps of,
providing a motive source,
providing a tool carrier assembly,
providing a means of attaching said earthworking tool to said tool carrier assembly,
providing a means of pivotably attaching said tool carrier assembly to said motive source, thereby allowing said tool carrier assembly to rotate controllably about a somewhat vertical axis, said somewhat vertical axis being somewhat perpendicular to said surface in situ,
engaging said earthworking tool with said surface in situ,
moving said tool carrier assembly in any direction on said surface in situ,
changing the direction of movement of said tool carrier assembly to any other direction on said surface in situ without disengaging said earthworking tool from said surface in situ,
whereby said tool carrier assembly is controllably rotated about said somewhat horizontal axis, on said surface in situ, as said tool carrier assembly is moved about said surface in situ without disengaging said earthworking tool from said surface in situ.

2. the method of claim # 1 wherein, said motive source further includes;
providing a lift arm assembly on said motive source,
providing a means of pivotably attaching said lift arm assembly to said motive source,
providing a means of selectively applying upward or downward force on said lift arm assembly,
providing a means of pivotably attaching said lift arm assembly, to said means of pivotably attaching said tool carrier assembly to said motive source,

3. the method of claim # 1 wherein said tool carrier assembly includes a depth guide.

4. the method of claim # 3 wherein; said depth guide includes, a ground contact surface, and a means by which said ground contact surface is rotateable about a somewhat horizontal axis.

5. the method of claim # 4 further including, a plurality of said depth guide.

6. the method of claim # 2 wherein said tool carrier assembly includes a depth guide.

7. the method of claim # 6 wherein said depth guide further includes a ground contact surface, and a means by which said ground contact surface is rotateable about a somewhat horizontal axis.

8. a method of working a surface in situ comprising the steps;
providing a motive source,
providing a tool carrier assembly,
providing a means of attaching an earthworking tool to said tool carrier assembly,
providing a means of pivotably attaching said tool carrier assembly to said motive source, thereby allowing said tool carrier assembly to rotate controllably about a somewhat vertical axis, said somewhat vertical axis being somewhat perpendicular to said surface in situ,
engaging said earthworking tool with said surface in situ,
moving said tool carrier assembly in any direction on said surface in situ,
changing the direction of movement of said tool carrier assembly to any other direction on said surface in situ without disengaging said earthworking tool from said surface in situ,
whereby said tool carrier assembly is controllably rotated about said somewhat vertical axis on said surface in situ, as said tool carrier assembly is moved about in any direction on said surface in situ without disengaging said earthworking tool from said surface in situ, and
whereby said surface in situ is worked to the desired shape or texture.

9. the method of claim # 8 wherein, said motive source further includes;
providing a lift arm assembly on said motive source,
providing a means of pivotably attaching said lift arm assembly to said motive source,
providing a means of selectively applying upward or downward force on said lift arm assembly,
Providing a means of pivotably attaching said lift arm assembly, to said means of pivotably attaching said tool carrier assembly to said motive source,

10. the method of claim # 8 wherein said tool carrier assembly includes a depth guide, and a means for attaching said depth guide to said tool carrier assembly.

11. the method of claim # 10 wherein, said depth guide further includes a ground contact surface, and a means by which said ground contact surface is rotateable about a somewhat horizontal axis.

12. The method of claim # 11 further including a plurality of said depth guide.

13. the method of claim # 9 wherein said tool carrier assembly includes a depth guide, and a means for attaching said depth guide to said tool carrier assembly.

14. the method of claim # 13 wherein said depth guide further includes; a ground contact surface, and a means by which said ground contact surface is rotateable about a somewhat horizontal axis.

15. the method of claim # 14 further including a plurality of said depth guide

16. the method of claim # 1 wherein said earthworking tool is a scraper blade.

17. the method of claim # 2 wherein said earthworking tool is a scraper blade.

18. the method of claim # 1 further providing a means by which said motive source can be moved in a cylconic or anticyclonic motion, whereby said motive source turns with a zero turning radius, thereby propelling said earthworking tool about said surface in situ with a somewhat cyclonic or anticyclonic motion.

19. the method of claim # 2 further comprising; providing a means to allow said lift arm assembly to be urged to move with a cyclonic or anticyclonic motion.

20. the method of claim # 9 further providing a means by which said motive source can be moved in a cylconic or anticyclonic motion, whereby said motive source turns with a zero turning radius, thereby propelling said earthworking tool about said surface in situ with a somewhat cyclonic or anticyclonic motion.
